(19) United States
(12) Patent Application Publication
(10) Pub. No.: US 2011/0066967 A1
(43) Pub. Date: Mar. 17, 2011

(54) INTAKE AND OUTPUT FLUID BALANCE VIEWER

(75) Inventors: David Allen Fraticelli, Sharpsburg, MD (US); Garrett Gardner Clarke, Washington, DC (US); Anthony William Glunt, Greencastle, PA (US)

(73) Assignee: Microsoft Corporation, Redmond, WA (US)

(21) Appl. No.: 12/560,432

(22) Filed: Sep. 16, 2009

(51) Int. Cl. G06F 3/048

(52) U.S. Cl. 715/777; 715/764

(57) ABSTRACT

Described is a technology by which fluid-related data of a selected patient may be displayed on an interactive user interface. A fluid balance component displays fluid balance-related data of the patient, and an intake/output detail component displays amounts of fluid received by and output by the patient at one or more date and times. A summary component displays a summary of the fluid intake, fluid output and fluid balance of the patient over an interval, which may be selectable. The selection between the components and their corresponding display screens may be done by interacting with tabs.

### BACKGROUND

Clinicians and other medical personnel need to check on the fluid balances (fluid intake and output) of patients. At present, however, there is no known way for clinicians to view intake and output data in a meaningful way in conjunction with other relevant patient data. For example, no known mechanism presently provides the ability to look at a broad list of patients (e.g., all patients with a potential fluid imbalance) and then allow the ability to obtain additional per-patient details.

Existing solutions are thus inefficient with respect to the amount of time a clinician has to take in order to find the data that is needed to make timely clinical decisions. In addition, current solutions are not flexible and/or costly to modify.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which fluid-related data of a selected patient may be displayed on an interactive user interface. An intake/output module includes a fluid balance component that displays fluid balance-related data of the patient, and an intake/output detail component that displays amounts of fluid received by and output by the patient at one or more date and times. A summary component may further display a summary of the fluid intake, fluid output and fluid balance of the patient over an interval.

In one implementation, the selection between the components and their corresponding display screens includes interactive tabs. One or more interval selection mechanisms may be associated with each component for changing the interval over which the fluid related data is displayed. Also described is a patient list user interface that shows a plurality of patients from which the patient may be selected.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components for providing fluid balance data to a user interface.

FIG. 2 is a representation of an example fluid balance screenshot that may be viewed by selecting a tab of an intake/output module.

FIG. 3 is a representation of an example intake/output detail screenshot that may be viewed by selecting a tab of an intake/output module.

FIG. 4 is a representation of an example intake/output summary screenshot that may be viewed by selecting a tab of an intake/output module

FIG. 5 shows an illustrative example of a computing environment into which various aspects of the present invention may be incorporated.

### DETAILED DESCRIPTION

Various aspects of the technology described herein are generally directed towards a flexible intake/output module that meets a given customer's reference ranges and/or specifications with respect to viewing patients' fluid balances. In one implementation, this module provides a user interface which, in one application, gives the ability to see patient fluid balance data in conjunction with patient data from multiple disparate systems. Further the user interface provides the ability for a viewer to further interact (“drill down”) to see more detailed fluid balance information for a selected patient. For example, this may be used to efficiently determine whether a patient's health is improving or deteriorating while in the hospital, by observing trends in the patient's fluid balance.

While Microsoft Amalga® UIS, a unified intelligence system/service that provides client users with access to clinical data, is used as an example herein of a system in which the intake/output module may be implemented, it should be understood that any of the examples described herein are non-limiting examples. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing, displaying clinical data, and user interface elements in general.

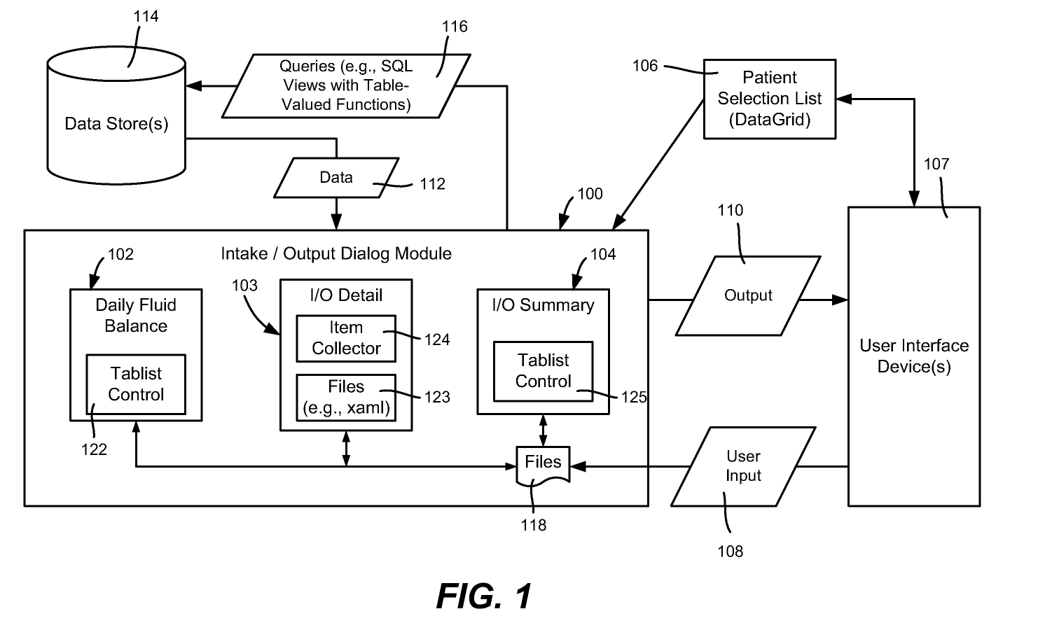

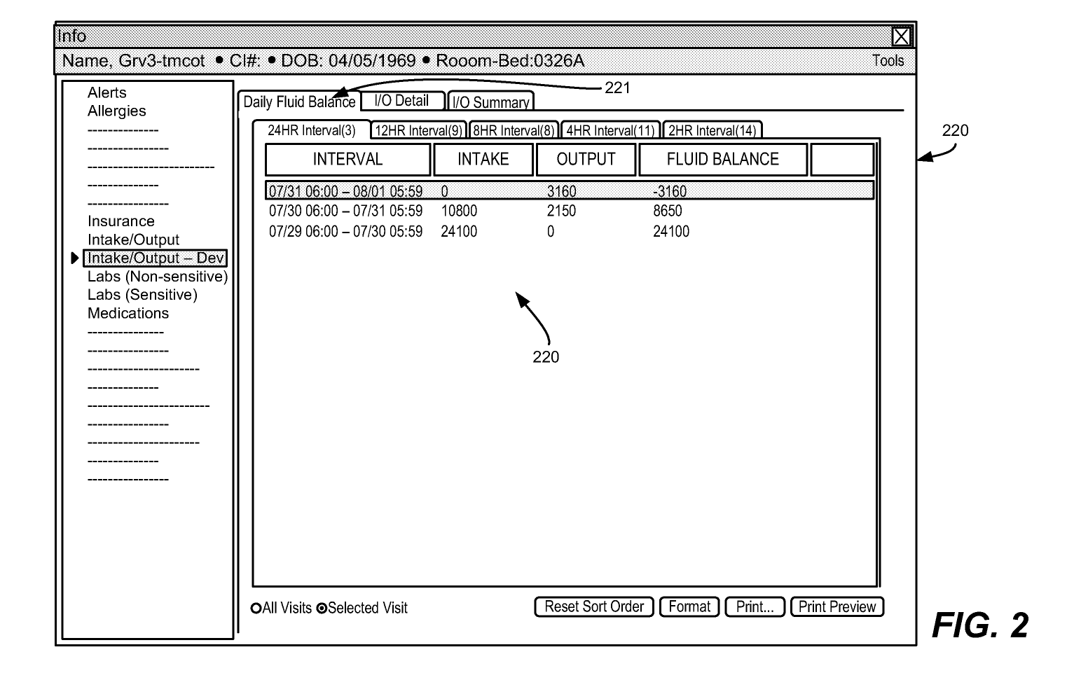

FIG. 1 shows various aspects related to the intake/output module 100. In one implementation, the intake/output module 100 comprises a XAML dialog manager screen that when rendered includes three hosted tabs, corresponding to components 102-104. Three tab-selected screens rendered within the XAML dialog manager screen are shown in more detail in FIGS. 2-4 (described below).

In general, prior to viewing the manager screen of the I/O module 100, the user (e.g., clinician) is presented with a list 106 of patients, e.g., at a data grid level via a data grid user interface element, such as listing those patients that are at risk of having a fluid imbalance over a given period of time (e.g., today). Then, via a user interface device or devices 107 (e.g., keyboard/pointing device and display, or touch-sensitive display), a user selects a patient from the list 106. This provides the ability to see the patients that potentially have a fluid imbalance at the data grid level, along with the ability to further interact and see the detailed fluid balance information for a selected patient.

Once a patient is selected, the user provides user input 108 to choose among the tabs, and receives visible output 110 corresponding to the selected tab. The data 112 that is displayed is retrieved from an appropriate data store or stores 114 based upon stored queries 116 comprising SQL views, functions and so forth, as described below.

In one implementation, the Intake/Output viewing module 100 uses

XAML code, which is interpreted by an Amalga® dialog manager; the Intake/Output Dialog Module may be hosted in the Amalga® Component launcher.ocx. In this implementation, using embedded XAML files 118, the Intake/Output module 100 passes user inputted fields to a next XAML file in order to display the desired data. The passing of the user input to the XAML files 118 for processing handles the variables that are sent to the stored queries 116 that retrieve the data that is subsequently displayed to the end user through selection of one of three tabs.

Turning to the tabs, the daily fluid balance component 102 hosts a TabList control 122 that outputs fluid data amounts for various tab-selectable intervals, e.g., twenty-four hours, twelve hours, eight hours, four hours or two hours by default. Different intervals can be selected by the user (customer) during initial module setup. An example rendered screen is represented in FIG. 2, which shows the fluid data 220 (intake, output and fluid balance) for tab 221 as measured within the currently chosen interval (e.g., the 24 HR tab) for the selected patient.

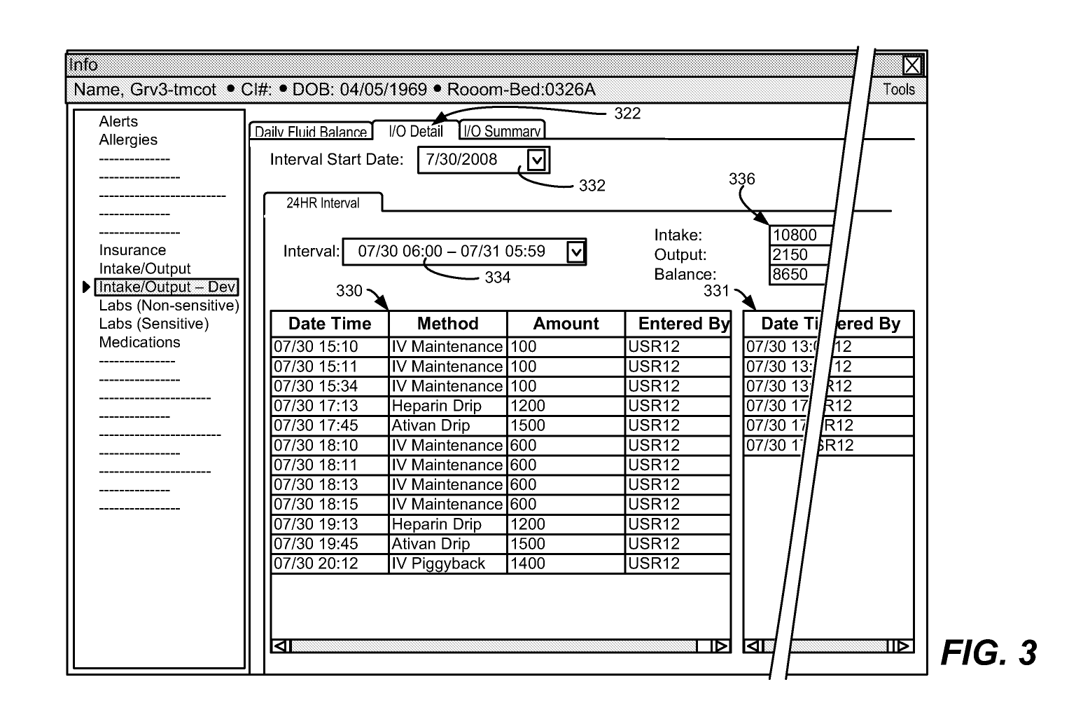

The second main (“I/O detail”) tab 322 corresponding to the Intake/Output detail component 103 hosts XAML files 123, and utilizes Amalga® Item Collector technology 124 to display the results in one or more grid like objects 330, 331 as represented in FIG. 3. Note that more than one grid may appear, e.g., alongside the other; a full grid representation and a partial grid representation are shown in FIG. 3; (in an actual screenshot, both grids may be fully visible). In this example, SQL table-valued functions and scalar value functions are used to display the drop down choices for each interval, and display the data.

To use the Intake/Output detail screen, the user selects an interval start date via UI element 332. From that date, an interval drop down UI element 334 populates with the available date choices. The user picks the particular interval of interest, which then is used to populate the Intake, Output, and Balance fields 336 and populate the item collectors (corresponding to grids 330 and 331) with data.

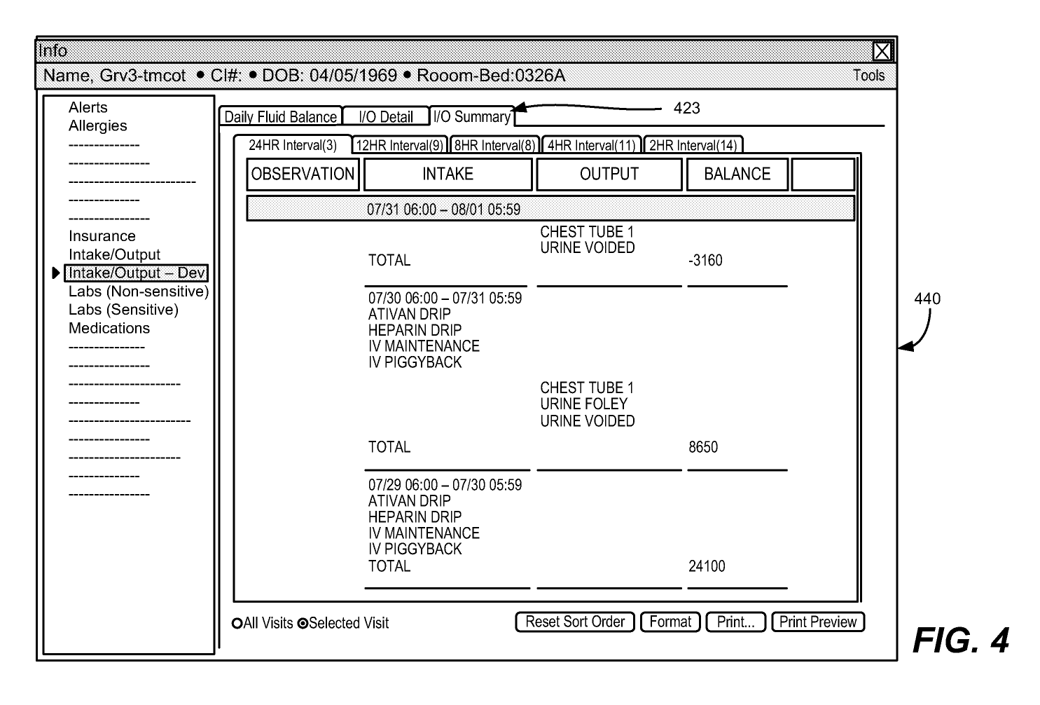

The “I/O Summary” tab 423, corresponding to the Intake/Output summary component 104, hosts a TabList Control 125. This screen 440, represented in FIG. 4, displays the total Intake, Output, and Balance fields that appear in the Intake and Output item collectors. The interval is selectable via the various interval tabs (24 HR, 12 HR, and so on) on the summary screen 440. As with other intervals, the interval tabs that appear are user configurable.

### EXEMPLARY OPERATING ENVIRONMENT

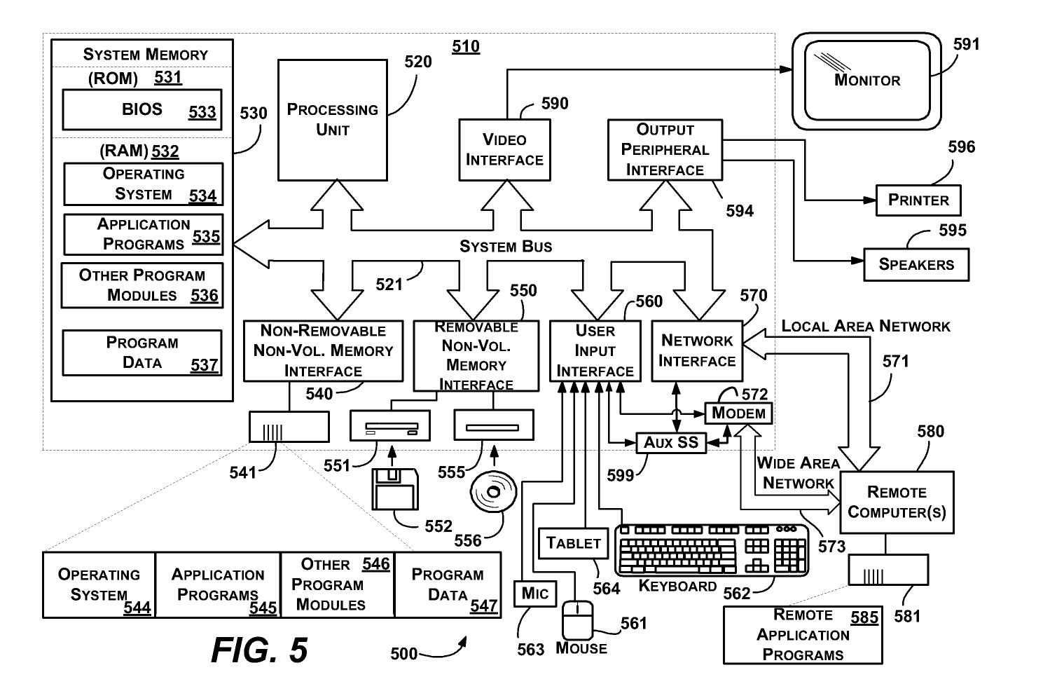

FIG. 5 illustrates an example of a suitable computing and networking environment 500 on which the examples of FIGS. 1-4 may be implemented. The computing system environment 500 is only one example of a suitable computing environment and is not intended to suggest any limitation as to the scope of use or functionality of the invention. Neither should the computing environment 500 be interpreted as having any dependency or requirement relating to any one or combination of components illustrated in the exemplary operating environment 500.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 5, an exemplary system for implementing various aspects of the invention may include a general purpose computing device in the form of a computer 510. Components of the computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 510 typically includes a variety of computer-readable media. Computer-readable media can be any available media that can be accessed by the computer 510 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 510. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536 and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media, described above and illustrated in FIG. 5, provide storage of computer-readable instructions, data structures, program modules and other data for the computer 510. In FIG. 5, for example, hard disk drive 541 is illustrated as storing operating system 544, application programs 545, other program modules 546 and program data 547. Note that these components can either be the same as or different from operating system 534, application programs 535, other program modules 536, and program data 537. Operating system 544, application programs 545, other program modules 546, and program data 547 are given different numbers herein to illustrate that, at a minimum, they are different copies. A user may enter commands and information into the computer 510 through input devices such as a tablet, or electronic digitizer, 564, a microphone 563, a keyboard 562 and pointing device 561, commonly referred to as mouse, trackball or touch pad. Other input devices not shown in FIG. 5 may include a joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. The monitor 591 may also be integrated with a touch-screen panel or the like. Note that the monitor and/or touch screen panel can be physically coupled to a housing in which the computing device 510 is incorporated, such as in a tablet-type personal computer. In addition, computers such as the computing device 510 may also include other peripheral output devices such as speakers 595 and printer 596, which may be connected through an output peripheral interface 594 or the like.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include one or more local area networks (LAN) 571 and one or more wide area networks (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560 or other appropriate mechanism. A wireless networking component such as comprising an interface and antenna may be coupled through a suitable device such as an access point or peer computer to a WAN or LAN. In a networked environment, program modules depicted relative to the computer 510, or portions thereof, may be stored in the remote memory storage device. By way of example, and not limitation, FIG. 5 illustrates remote application programs 585 as residing on memory device 581. It may be appreciated that the network connections shown are exemplary and other means of establishing a communications link between the computers may be used.

An auxiliary subsystem 599 (e.g., for auxiliary display of content) may be connected via the user interface 560 to allow data such as program content, system status and event notifications to be provided to the user, even if the main portions of the computer system are in a low power state. The auxiliary subsystem 599 may be connected to the modem 572 and/or network interface 570 to allow communication between these systems while the main processing unit 520 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a system comprising, an intake/output module that displays fluid-related data of a patient selected from among a plurality of patients, including a fluid balance component that displays fluid balance-related data of the patient, and an intake/output detail component that displays amounts of fluid received by and output by the patient at one or more date and times.

2. The system of claim 1 further comprising a summary component that displays a summary of the fluid intake, fluid output and fluid balance of the patient over an interval.

3. The system of claim 2 further comprising an interval selection mechanism associated with the summary component for changing the interval over which the summary is displayed.

4. The system of claim 1 further comprising a selection mechanism for choosing to display the fluid balance-related data of the patient, and for choosing to display the amounts of fluid received by and output by the patient.

5. The system of claim 4 wherein the selection mechanism includes one interactive tab for choosing to display the fluid balance-related data of the patient, and another interactive tab for choosing to display the amounts of fluid received by and output by the patient.

6. The system of claim 1 further comprising a patient list user interface that shows the plurality of patients from which the patient is selected.

7. The system of claim 6 wherein the patient list user interface comprises a datagrid user interface element.

8. The system of claim 1 further comprising a fluid balance interval selection mechanism associated with the fluid balance component for changing the interval over which the fluid balance is displayed.

9. The system of claim 1 further comprising an intake/output detail interval selection mechanism associated with the intake/output detail component for changing the interval over which the amounts of fluid received by and output by the patient is displayed.

10. The system of claim 1 wherein the intake/output module includes at least one tab list control.

11. The system of claim 1 wherein the intake/output detail component comprises at least one I/O collector.

12. The system of claim 1 wherein the intake/output module includes queries or functions, or both queries and functions, for retrieving the fluid-related data.

13. An a computing environment, a method comprising, presenting a patient list that relates each patient on the list to fluid-related data of that patient, detecting interaction with the patient list to select a patient, and providing fluid-related data for the selected patient, including intake/output and fluid balance data with respect to at least one interval.

14. The method of claim 13 further comprising, detecting interaction by which a user selects the interval.

15. The method of claim 13 wherein providing the fluid-related data for the selected patient comprises presenting a fluid balance screen, an intake/output detail screen, or an intake/output summary screen, or any combination of a fluid balance screen, an intake/output detail screen, or an intake/output summary screen.

16. The method of claim 15 wherein providing the fluid-related data for the selected patient comprises presenting interactive tabs, including a tab that when selected displays the fluid balance screen, a tab that when selected displays the intake/output detail screen, and a tab that when selected displays the intake/output summary screen.

17. In a computing environment, a system comprising, a user interface that that displays fluid-related data of a patient, including a fluid balance screen that displays fluid balance-related data of the patient, an intake/output detail screen that displays amounts of fluid received by and output by the patient at one or more date and times, and the user interface including at least one interval selection mechanism for selecting an interval over which to display the fluid-related data.

18. The system of claim 17 wherein the user interface further comprises an intake/output summary screen that displays a summary of the fluid-related data of the patient.

19. The system of claim 18 wherein the user interface includes interactive tabs for selecting between the fluid balance screen, the intake/output detail screen, and the intake/output summary screen.

20. The system of claim 17 wherein the intake/output detail screen includes a grid that shows amounts of fluid received by the patient with respect to dates and times corresponding to when the fluid was received.
